(19) United States
(12) Patent Application Publication
(10) Pub. No.: US 2025/0257203 A1
(43) Pub. Date: Aug. 14, 2025

(54) RHEOLOGY MODIFIER FOR RECYCLED POLYPROPYLENE

(71) Applicant: Fina Technology, Inc., Houston, TX (US)

(72) Inventors: Fengkui Li, Houston, TX (US); Peng Li, Sugar Land, TX (US); Joachim Azzi, Houston, TX (US)

(73) Assignee: Fina Technology, Inc., Houston, TX (US)

(21) Appl. No.: 19/049,928

(22) Filed: Feb. 10, 2025

Related U.S. Application Data
(60) Provisional application No. 63/552,542, filed on Feb. 12, 2024.

(51) Int. Cl. C08L 23/12

(52) U.S. Cl. CPC C08L 23/12; C08L 2205/025; C08L 2207/20

(57) ABSTRACT

A method of preparing a vis-broken recycled polypropylene comprising contacting (i) a recycled polypropylene and (ii) an optional virgin polypropylene with a rheology modifier to form a mixture; and subjecting the mixture to reactive extrusion.

### CROSS-REFERENCE TO RELATED APPLICATIONS

This application claims benefit of U.S. provisional patent application Ser. No. 63/552,542 filed Feb. 12, 2024 and entitled “RHEOLOGY MODIFIER FOR RECYCLED POLYPROPYLENE,” which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The present disclosure relates generally to polypropylene compositions. More particularly, the present disclosure relates to rheology modifiers for use in compositions containing recycled polypropylene.

### BACKGROUND

Polypropylene (PP) is a widely used plastic that has high modulus, high tensile strength, good heat resistance, and other favorable properties in the solid-state. Synthetic polymeric materials, particularly polypropylene resins, are manufactured into a variety of end-use articles ranging from medical devices to packaging materials.

The processability of polypropylene is associated with a high melt flow rate (MFR) that is an important factor for molding applications that ensures superior output and finished product quality. The most commonly used technique in the PP industry to achieve a desirable MFR and melt viscosity is through a process termed vis-breaking. “Vis-breaking” or “controlled rheology” refers to the addition of a degrading agent (e.g., peroxide) to a resin as it is processed in an extruder to induce chain scission along the polymer backbone. The amount of viscosity reduction or vis-breaking is controlled by factors such as the type and amount of degrading agent introduced.

In the production of propylene polymers, i.e., polypropylene and crystalline copolymers, the molecular weight of the polymerized product may be closely controlled at any desired level above about 200,000 weight average molecular weight (Mw) which corresponds to a melt flow rate (MFR) of up to about 20 dg/min at 230° C. Yields of crystalline propylene polymers with a MFR above about 20 dg/min made directly through polymerization are impractically low. To produce lower molecular weight products, the propylene polymer is typically subjected to vis-breaking. This process not only lowers the molecular weight of the polypropylene and raises the melt flow rate, but it also leads to a narrowing of the molecular weight distribution.

One measure of the molecular weight distribution is the ratio of the weight average molecular weight to the number average molecular weight (Mw/Mn), also termed the polydispersity index. A vis-broken polymer of a given molecular weight has a better balance of processing and physical properties when compared to a non-vis-broken polymer having the same molecular weight. For example, a common procedure is to generate polypropylene at a higher molecular weight than desired for the final application and then to vis-break the polymer to the desired molecular weight.

An ongoing consideration when employing vis-breaking is the transportation, storage, and processing of degradation agents such as peroxides, both in liquid and powder form. Specifically, these activities are subject to stringent safety regulations due to the flammability and highly reactive characteristics of peroxides. Furthermore, achieving proper dosage and homogenous incorporation of liquid peroxides can be challenging during the preparation of compositions such as those having a combination of recycled and virgin resins. These situations tend to require specialized dosage equipment and expertise in materials handling. An ongoing need exists for an alternative to conventional vis-breaking, there is a high demand for efficient and economically viable approaches to tailor the MFR of resin materials

### BRIEF SUMMARY OF THE DISCLOSURE

Disclosed herein is a method of preparing a vis-broken recycled polypropylene comprising contacting (i) a recycled polypropylene and (ii) an optional virgin polypropylene with a rheology modifier to form a mixture; and subjecting the mixture to reactive extrusion.

Aspects described herein comprise a combination of features and characteristics intended to address various shortcomings associated with certain prior devices, systems, and methods. The foregoing has outlined rather broadly the features and technical characteristics of the disclosed aspects in order that the detailed description that follows may be better understood. The various characteristics and features described above, as well as others, will be readily apparent to those skilled in the art upon reading the following detailed description, and by referring to the accompanying drawings. It should be appreciated that the conception and the specific aspects disclosed may be readily utilized as a basis for modifying or designing other structures for carrying out the same purposes as the disclosed aspects. It should also be realized that such equivalent constructions do not depart from the spirit and scope of the principles disclosed herein.

### BRIEF DESCRIPTION OF THE DRAWINGS

For a detailed description of various exemplary aspects, reference will now be made to the accompanying drawings in which:

FIG. 1A is a graph of the melt flow rates for samples 1, 2, and 3.

FIG. 1B is a graph of the tensile modulus for samples 1, 2, and 3.

FIG. 1C is a graph of the Izod impact strength for samples 1, 2, and 3.

FIG. 1D is a graph of the tensile yield strength for samples 1, 2, and 3.

FIG. 1E is a graph of the melt flow rates for samples 4, 5, and 6.

FIG. 1F is a graph of the tensile modulus for samples 4, 5, and 6.

FIG. 1G is a graph of the Izod impact strength for samples 4, 5, and 6.

FIG. 1H is a graph of the tensile yield strength for samples 4, 5, and 6.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . ” As used herein, the phrases “consist(s) of” and “consisting of” are used to refer to exclusive components of a composition, meaning only those expressly recited components are included in the composition; whereas the phrases “consist(s) essentially of” and “consisting essentially of” are used to refer to the primary components of a composition, meaning that only small or trace amounts of components other than the expressly recited components (e.g., impurities, byproducts, etc.) may be included in the composition. For example, a composition consisting of X and Y refers to a composition that only includes X and Y, and thus, does not include any other components; and a composition consisting essentially of X and Y refers to a composition that primarily comprises X and Y, but may include small or trace amounts of components other than X and Y. In embodiments described herein, any such small or trace amounts of components other than those expressly recited following the phrase “consist(s) essentially of” or “consisting essentially of” preferably represent less than 5.0 wt % of the composition, more preferably less than 4.0 wt % of the composition, even more preferably less than 3.0 wt % of the composition, and still more preferably less than 1.0 wt % of the composition. Use of broader terms such as comprises, includes, having, etc. should be understood to provide support for narrower terms such as consisting of, consisting essentially of, comprised substantially of, etc. Use of the term “optionally” with respect to any element of a claim is intended to mean that the subject element is required, or alternatively, is not required. Both alternatives are intended to be within the scope of the claim. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Disclosed herein are rheological modifiers for use in vis-breaking recycled polypropylene. In other aspects, the compositions being vis-broken comprise a blend of recycled polypropylene and virgin polypropylene. In other aspects, the compositions being vis-broken consist of recycled polypropylene. In either aspect, the polypropylene contacted with the rheology modifier is termed the target polypropylene and designated PP-t.

Rheology is the study of how materials flow as a function of shear (also termed the load rate), time and spatial orientation. Rheological modifiers generally function to mediate particle interactions through a variety of mechanisms such as the modifying the nature of the particles themselves and/or the ionic strength of the electrostatic interactions. Rheological modifiers can affect multiple rheological characteristics including viscosity modification, control of flow behavior, settling prevention, texture enhancement and stability improvement.

In one or more aspects, a PP-t comprises (i) a virgin polypropylene and (ii) a recycled polypropylene. In one or more aspects, a method of the present disclosure comprises contacting a PP-t with a virgin high melt flow rate (MFR) polypropylene under conditions suitable to improve form a vis-broken PP-t, hereinafter designated rPP-V. The rPP-V may have one or more performance properties of the PP-t improved to a level sufficient to achieve some user and/or process goal.

In one or more aspects, the PP-t comprises a recycled polypropylene such as that obtained from recycled polymer waste. Herein the term “recycled polymer waste” is used to indicate a polymer material recovered from either post-consumer waste or post-industrial waste. In one or more aspects, the recycle polypropylene is a post-consumer recycled resin or PCR. In one or more aspects, the recycled polypropylene is a post-industrial recycled resin or PIR. PCR is obtained from objects having completed at least a first use cycle (or life cycle), i.e. having already served their first purpose; while PIR refers to resin obtained from manufacturing scrap, which has not normally reached a consumer

In one or more aspects, the recycled polypropylene comprises a polypropylene homopolymer, a polypropylene impact copolymer, a polypropylene random copolymer or combinations thereof. The term “polypropylene impact copolymer” refers to thermoplastic resins produced through the polymerization of propylene and ethylene characterized by a heterophasic amorphous structure inside a semi-crystalline polypropylene homopolymer matrix. The term “polypropylene random copolymer” refers to thermoplastic resins produced through the polymerization of propylene, with ethylene or butene bonds introduced in the polymer chain. The expression “propylene homopolymer” refers to a polypropylene that consists substantially of propylene units (e.g., greater than about 95%). A polypropylene suitable for use in the present disclosure may have been prepared using any suitable catalyst (e.g., Ziegler Natta, metallocene, etc.). is to be understood that a recycled polypropylene may comprise polypropylene sourced from any number of sources and consequently will contain polypropylene prepared with any number of differing catalysts. For example, the recycled polypropylene may contain a combination of Ziegler Natta catalyzed resin and metallocene catalyzed resin.

A recycled polypropylene suitable for use in this disclosure may have a density, as determined in accordance ASTM D1505, of from about 0.85 grams per cubic centimeter (g/cc) to about 0.92 g/cc, additionally or alternatively, from about 0.88 g/cc to about 0.92 g/cc or, additionally or alternatively, from about 0.90 g/cc to about 0.91 g/cc. In one or more aspects, a recycled polypropylene suitable for use in this disclosure may have a melt flow rate (MFR), as determined in accordance with ASTM D1238, of from about 1.0 decagrams per minute (dg/min.) to about 50 dg/min., additionally or alternatively from about 5.0 dg/min. to about 50 dg/min., additionally or alternatively from about 5.0 dg/min. to about 30 dg/min. The MFR is a measurement of the viscosity of a polymer through a defined orifice at a constant temperature and can be determined in accordance with ASTM D1238.

In some aspects, a recycled polypropylene suitable for use in this disclosure may have a flexural modulus, as determined in accordance with ASTM D790, of from about 100,000 pounds per square inch (psi) to about 300,000 psi, additionally or alternatively from about 120,000 psi to about 280,000 psi, additionally or alternatively from about 150,000 psi to about 250,000 psi.

In some aspects, a recycled polypropylene suitable for use in this disclosure may have a tensile yield strength, as determined in accordance with ASTM D638, of from about 2000 psi to about 7000 psi, additionally or alternatively from about 2000 psi to about 6000 psi, additionally or alternatively from about 3000 psi to about 5000 psi.

In some aspects, a recycled polypropylene suitable for use in this disclosure may have an Izod impact, as determined in accordance with ASTM D-256, of from about 0.2 ft-lb/in to about 5 ft-lb/in, additionally or alternatively from about 0.3 ft-lb/in to about 4.0 ft-lb/in, additionally or alternatively from about 0.3 ft-lb/in to about 3.0 ft-lb/in.

In one or more aspects, a recycled polypropylene suitable for use in this disclosure is characterized by the following melt profile as determined by differential scanning calorimetry; a recrystallization peak of from about 70° C. to about 140° C.; additionally or alternatively from about 80° C. to about 140° C.; additionally or alternatively from about 90° C. to about130° C.; a melt peak ranging from about 120° C. to about 170° C. additionally or alternatively from about 130° C. to about 170° C. additionally or alternatively from about 140° C. to about170° C.; and a percentage crystallinity ranging from about 20% to about 70% additionally or alternatively from about 30% to about 60% additionally or alternatively from about 40% to about 60%.

In one or more aspects, the PP-t comprises a virgin polypropylene where the term “virgin denotes newly produced materials and/or objects prior to their first use, which have not already been recycled.

In one or more aspects, a virgin polypropylene resin for use in the PP-t is a reactor grade resin which refers to a product obtained from a polymerization reactor without further processing. In one or more other aspects, a virgin polypropylene resin for use in the present disclosure has previously been vis-broken but not utilized in the formation of an end use article. For example, the polypropylene may be a resin that following recovery from a reactor is subjected to vis-breaking using any suitable methodology (e.g., contacting with a peroxide, thermal vis-breaking, etc.). In one or more aspects, the rheology modifier may be characterized as having reactive peroxide present in amounts ranging from about 0.05 wt. % to about 0.5 wt. % alternatively or additionally from about 0.1 wt. % to about 0.3 wt. % alternatively from about 0.1 wt. % to about 0.2 wt. %.

In one or more aspects, the virgin polypropylene comprises a polypropylene homopolymer, a polypropylene impact copolymer, a polypropylene copolymer or combinations thereof. Nonlimiting examples of polypropylene copolymers suitable for use in the present disclosure include copolymers of propylene with olefinic comonomers such as ethylene, propylene, butenes, pentenes, hexenes, heptenes, octenes, nonenes, decenes and alpha-olefins.

In one or more aspects, the virgin polypropylene is characterized by a may have a molecular weight distribution or polydispersity index of from about 2 to about 15, additionally or alternatively from about 2 to about 12, additionally or alternatively from about 2 to about 10.

The virgin polypropylene may have a density of from about 0.85 g/cc to about 0.92 g/cc, additionally or alternatively from about 0.88 g/cc, to about 0.92 g/cc, additionally or alternatively from about 0.90 g/cc, to about 0.91 g/cc.

The virgin polypropylene may have a MFR of from about 1.0 g/10 min about 200 g/10 min, additionally or alternatively from about 10 g/10 min to about 150 g/10 min, additionally or alternatively from about 40 g/10 min to about 150 g/10 min at a temperature of 230° C. and a load of 2.16 kg as determine in accordance with ASTM D-1238

In some aspects, the virgin polypropylene can have a xylene soluble content of from about 0.5 wt. % to about 30 wt. % additionally or alternatively from about 0.5 wt. % to about 25 wt. %, additionally or alternatively from about 1 wt. % to about 20 wt. % as determined in accordance with ASTM D5492.

In some aspects, the virgin polypropylene can have a flexural modulus of from about 100 Kpsi to about 300 Kpsi additionally or alternatively from about 120 Kpsi to about 280 Kpsi, additionally or alternatively from about 150 Kpsi to about 250 Kpsi as determined in accordance with ASTM D790-97.

In some aspects, a virgin polypropylene suitable for use in this disclosure may have an Izod impact, as determined in accordance with ASTM D-256, of from about 0.2 ft-lb/in to about 10 ft-lb/in, additionally or alternatively from about 0.3 ft-lb/in to about 4.0 ft-lb/in, additionally or alternatively from about 0.3 ft-lb/in to about 3.0 ft-lb/in.

In one or more aspects, the virgin polypropylene is characterized by the following melt profile as determined by differential scanning calorimetry a recrystallization peak of from about 70° C. to about 140° C., additionally or alternatively from about 80° C. to about 140° C., additionally or alternatively from about 90° C. to about 140° C.; a melt peak ranging from about 120° C. to about 170° C. additionally or alternatively from about 130° C. to about 170° C. additionally or alternatively from about 140° C. to about 170° C.; and a percentage crystallinity ranging from about 20% to about 70% additionally or alternatively from about 30% to about 60% additionally or alternatively from about 40% to about 60%.

In some aspects, a PP-t comprises a recycled polypropylene (e.g., PIR, PCR) in amounts ranging from about 0.1 weight percent (wt. %) to about 100 wt. %, additionally or alternatively from about 10 wt. % to about 90 wt. %, additionally or alternatively from about 25 wt. % to about 75 wt. % based on the total weight of resin in the PP-t.

In other aspects, the PP-t comprises a recycled polypropylene present in an amount of about 1 wt. %, about 2 wt. %, about 4 wt. %, about 6 wt. %, about 8 wt. %, about 10 wt. %, about 12 wt. %, about 14 wt. %, about 16 wt. %, about 18 wt. %, about 20 wt. %, about 22 wt. %, about 24 wt. %, about 26 wt. %, about 28 wt. %, about 30 wt. %, about 32 wt. %, about 34 wt. %, about 36 wt. %, about 38 wt. %, about 40 wt. %, about 42 wt. %, about 44 wt. %, about 46 wt. %, about 48 wt. %, about 50 wt. %, about 52 wt. %, about 54 wt. %, about 56 wt. %, about 58 wt. %, about 60 wt. %, about 62 wt. %, about 64 wt. %, about 66 wt. %, about 68 wt. %, about 70 wt. %, about 72 wt. %, about 74 wt. %, about 76 wt. %, about 78 wt. %, about 80 wt. %, about 82 wt. %, about 84 wt. %, about 86 wt. %, about 88 wt. %, about 90 wt. %, about 92 wt. %, about 94 wt. %, about 96 wt. %, about 98 wt. %, or about 99 wt. % based on the total weight of the rPP-V. In one or more aspects, the remainder of polymer in the PP-t comprises virgin polypropylene. In some aspects, the PP-t comprises 99% of a recycled polypropylene (e.g., PIR, PCR, or both). In some aspects, the PP-t comprises 100% of a recycled polypropylene (e.g., PIR, PCR, or both).

In one or more aspects, an rPP-V is prepared by vis-breaking of a PP-t (e.g., 50% virgin polypropylene/50% recycled polypropylene) with a rheology modifier. Herein a rheology modifier suitable for use in the present disclosure comprises a vis-broken polypropylene with a significant reactive peroxide content. The term “reactive peroxide content” in a polymer refers to the amount of peroxide molecules present within a polymer chain that are readily able to break apart and form free radicals, which can then initiate further chemical reactions like degradation. Without wishing to be limited by theory, the rheology modifier is a polymer carrier of peroxide.

In one or more aspects, a the rPP-V blend is prepared by contacting the PP-t with a rheology modifier having a reactive peroxide content level of equal to or less than about 2000 parts per million (ppm), additionally or alternatively from about 200 ppm to about 2000 ppm, additionally or alternatively from about 500 ppm to about 2000 ppm, additionally or alternatively from about 750 ppm to about 2000 ppm, additionally or alternatively from about 1000 ppm to about 2000 ppm.

A rheology modifier for use in the present disclosure may comprise a polypropylene homopolymer having a MFR of from about 600 g/10 min. to about 2200 g/10 min., a additionally or alternatively from about 800 g/10 min. to about 2200 g/10 min., additionally or alternatively from about 800 g/10 min. to about 1500 g/10 min as determined in accordance with ASTM D 1238 at 230° C. and a load of 2.16 kg; a weight average molecular weight (Mw) of from about 90,000 g/mol to about 200,000 g/mol, additionally or alternatively from about 90,000 g/mol to about 150,000 g/mol or additionally or alternatively about 130,000 g/mol as determined by gas phase chromatography; and a melting temperature (Tm) of from about 155° C. to about 170° C., additionally or alternatively from about 160° C. to about 170° additionally or alternatively about 165° C. as determined by differential scanning calorimetry. In one or more aspects, the rheology modifier comprises PROPYLENE 3962 propylene homopolymer which is a polypropylene resin commercially available from TotalEnergies.

The rheology modifier may be contacted with a PP-t in amounts effective to impart the desired performance characteristics (such as melt flow rate) and form a rPP-V, The amount of rheology modifier introduced to the PP-t will depend on a variety of factors such as the type of polypropylene present in the PP-t and the initial MFR of the PP-t. The amount of rheology modifier contacted with the PP-t may range from about 2 wt. % to about 30 wt. % additionally or alternatively from about 5 wt. % to about 25 wt. % additionally or alternatively from about 5 wt. % to about 20 wt. % based on the total weight of the final composition.

Contacting of the PP-t may be carried out in one or more extruders such as a twin screw extruder. Generally, an extruder such as a twin screw extrusion machine consists of two parallel screws that rotate in opposite directions and are housed inside a barrel. The raw material is fed into the barrel through a hopper and is transported through the screws towards the end of the barrel. In some aspects, the may be communicated through the screws under suitable processing parameters which may include, for example, a melting temperature of from about 300° F. to about 600° F. additionally or alternatively from about 350° F. to about 500° F. additionally or alternatively from about 400° F. to about 5500° F. at an extruder speed of from about 50 rpm to about 1000 rpm additionally or alternatively from about 100 rpm to about 500 rpm additionally or alternatively from about 100 rpm to about 300 rpm.

A rPP-V may further comprise one or more additives to impart some user and/or process desired property to the composition. Nonlimiting examples of additives suitable for inclusion in the rPP-V are colorants, cavitating agents, slip agents, antioxidants, anti-fog agents, anti-static agents, anti-block agents, fillers, moisture barrier additives, gas barrier additives, gas scavengers, neutralizers, and combinations thereof. Such additives may be used singularly or in combination in effective amounts, which vary depending upon the property desired. In one or more aspects, rPP-V comprises one or more performance modifiers (e.g., DELTAMAX commercially available from Miliken), one or more multiply unsaturated carbon compounds or combinations thereof.

In one or more aspects, an rPP-V may be characterized by a MFR ranging from about 10 dg/min to about 200 dg/min, additionally or alternatively from about 30 dg/min to about 100 dg/min, additionally or alternatively from about 40 dg/min to about 100 dg/min as determined in accordance with ASTM D-1238.

In one or more aspects, an rPP-V is characterized by a tensile modulus ranging from about 100 kilopound force per square inch (kpsi) to about 300 kpsi, additionally or alternatively from about 150 kpsi to about 300 kpsi additionally or alternatively from about 150 kpsi to about 250 kpsi as determined in accordance with ASTM D-638.

In one or more aspects, an rPP-V is characterized by an Izod impact strength ranging from about 0.1 foot pound per inch (ft-lb/in) to about 30 ft-lb/in, additionally or alternatively from about 0.1 ft-lb/into about 20 ft-lb/in additionally or alternatively from about 0.1 ft-lb/into about 15 ft-lb/in as determined in accordance with ASTM D-256A.

In one or more aspects, an rPP-V is characterized by a tensile yield strength ranging from about 2000 pounds per square inch (psi) to about 6000 psi, additionally or alternatively from about 2500 psi to about 5000 psi additionally or alternatively from about 2500 psi to about 5000 psi as determined in accordance with ASTM D-638.

In one or more aspects, the rPP-V is characterized by the following melt profile as determined by differential scanning calorimetry; a recrystallization peak of from about 70° C. to about 140° C., additionally or alternatively from about 80° C. to about 14° C., additionally or alternatively from about 90° C. to about 140° C.; a peak melt ranging from about 120° C. to about 170° C. additionally or alternatively from about 130° C. to about 170° C. additionally or alternatively from about 140° C. to about 170° C.; and a percentage crystallinity ranging from about 20% to about 70% additionally or alternatively from about 30% to about 60% additionally or alternatively from about 40% to about 60%.

In one or more aspects, the rPP-V is molded into an end use article. Molding of the rPP-V may be carried out using any suitable molding method. Nonlimiting examples of suitable molding methods include injection molding, extrusion molding, blow molding, vacuum molding, inflation molding, calendar molding, slush molding method, dip molding, and foam molding. In other aspects, the rPP-V is used in the formation of films or sheets through methods such as sheet extrusion thermoforming. In other aspects, the rPP-V is used in the formation of fibers.

Nonlimiting examples of end use articles formed from a rPP-V include resin parts for automobiles, such as a bumper, a dashboard, an instrument panel, a molding, an interior surface material, and a packing; resin parts for household appliances, such as a refrigerator, a washing machine, and a vacuum cleaner; household goods such as a tableware, a bucket, and a bathing implement; connecting parts such as connectors; miscellaneous goods such as toys; storage containers such as a tank and a bottle; medical supplies such as a medical pack, a syringe, a catheter, and a medical tube; building materials such as a wall material, a flooring material, a window frame, and wallpaper; agricultural materials such as an electric wire covering material, a house, and a tunnel; food packaging materials such as a wrap and a tray; various molded articles such as a film and a sheet; and fibers.

The present disclosure describes the use of a low-cost rheology modifier, (e.g., TotalEnergies 3962 polypropylene homopolymer) to effectively improve the MFR of recycled polypropylene containing formulations. Polypropylene 3962 is a homopolymer PP with a MFR of 1300 dg/min determined according to ASTM-D1238. 3962 has a recrystallization temperature of 116° C., a melting temperature of 162° C., and a percentage crystallinity of 50% according to Differential Scanning calorimeter (DSC). Typically recycled polypropylene compounding involves the blending of resin feedstock in flake and/or pellet forms. In such aspects it may be challenging to utilize liquid peroxides to vis-break rPP-V-containing flakes and pellets. To achieve good reproducible results, solid peroxide masterbatches are typically used. However, commercially available peroxide masterbatches are expensive and would add more significant cost to final hybrid compounds. The rheology modifiers disclosed herein provide for a low-cost peroxide masterbatch that results in vis-broken recycled polypropylene compositions with comparable performance to those produced from other costly commercial peroxide masterbatches.

### ADDITIONAL DISCLOSURE

A first aspect which is a method of preparing a vis-broken recycled polypropylene comprising contacting (i) a recycled polypropylene and (ii) an optional virgin polypropylene with a rheology modifier to form a mixture; and subjecting the mixture to reactive extrusion.

A second aspect which is a method of the first aspect wherein the recycled polypropylene is sourced from recycled polymer waste.

A third aspect which is the method of the second aspect wherein the recycled polymer waste comprises post-consumer waste.

A fourth aspect which is a method of the second aspect wherein the recycled polymer waste comprises post-industrial waste.

A fifth aspect which is the method of any of the first through fourth aspects wherein the recycled polypropylene comprises a polypropylene homopolymer, a polypropylene impact copolymer, a polypropylene random copolymer or combinations thereof.

A sixth aspect which is the method of any of the first through fifth aspects wherein the recycled polypropylene has a density of from about 0.85 g/cc to about 0.92 g/cc as determined in accordance ASTM D1505.

A seventh aspect which is the method of any of the first through sixth aspects wherein the recycled polypropylene has a melt flow rate, of from about 1 dg/min. to about 50 dg/min as determined in accordance with ASTM D1238.

An eighth aspect which is the method of any of the first through seventh aspects wherein the recycled polypropylene has a flexural modulus of from about 100 Kpsi to about 300 Kpsi as determined in accordance with ASTM D790.

A ninth aspects which is the method of any of the first through eighth aspects wherein the recycled polypropylene has a tensile yield strength of from about 2000 psi to about 6000 psi as determined in accordance with ASTM D638.

A tenth aspect which is the method of any of the first through ninth aspects wherein the recycled polypropylene has an Izod impact of from about 0.2 ft-lb/in to about 5.0 ft-lb/in as determined in accordance with ASTM D-256.

An eleventh aspect which is the method of any of the first through tenth aspects wherein the recycled polypropylene has a recrystallization peak of from about 70° C. to about 140° C.

A twelfth aspect which is the method of any of the first through eleventh aspects wherein the recycled polypropylene has a peak melt ranging from about 130° C. to about 170° C.

A thirteenth aspect which is the method of any of the first through twelfth aspects wherein the recycled polypropylene has a percentage crystallinity ranging from about 20% to about 70%.

A fourteenth aspect which is the method of any of the first through thirteenth aspects wherein the rheology modifier has a reactive peroxide content level of equal to or less than about 2000 parts per million (ppm).

A fifteenth aspect which is the method of any of the first through fourteenth aspects wherein the rheology modifier comprises a polypropylene homopolymer having a melt flow rate of from about 600 g/10 min to about 2200 g/10 min.

A sixteenth aspect which is the method of any of the first through fifteenth aspects wherein the rheology modifier has a weight average molecular weight of from about 90,000 g/mol to about 150,000 g/mol.

A seventeenth aspect which is the method of any of the first through sixteenth aspects wherein the virgin polypropylene is characterized by a molecular weight distribution of from about 2.0 to about 15.

An eighteenth aspect which is the method of any of the first through seventeenth aspects wherein the virgin polypropylene has a density of from about 0.85 g/cc to about 0.92 g/cc.

A nineteenth aspect which is the method of any of the first through eighteenth aspects wherein the virgin polypropylene has a MFR of from about 1 dg/min to about 200 dg/min as determined in accordance with ASTM D-1238.

A twentieth aspect which is the method of any of the first through nineteenth aspects wherein the virgin polypropylene has a tensile modulus ranging from about 100 kpsi to about 300 kpsi as determined in accordance with ASTM D-638.

A twenty-first aspect which is the method of any of the first through twentieth aspects wherein the virgin polypropylene has an Izod impact strength ranging from about 0.2 ft-lb/in to about 10 ft-lb/in as determined in accordance with ASTM D-256A.

### EXAMPLES

The aspects having been generally described, the following examples are given as particular aspects of the disclosure and to demonstrate the practice and advantages thereof. It is understood that the examples are given by way of illustration and are not intended to limit the specification of the claims in any manner.

### Example 1

The ability of a rheological modifier to alter the performance properties of a recycled polypropylene blend was investigated. Specifically, an ultra-high MFR resin, POLYPROPYLENE 3962, was used to produce rPP-V compositions. The initial compositions contained a combination of the polypropylene impact copolymer 5946WZ and 30% of a recycled polypropylene resin. 5946WZ is a polypropylene impact copolymer commercially available from TotalEnergies. Two types of rPP-V formulations were compounded: (i) Copolymer BANYAN 1582 which is a polypropylene having a 70/30 ratio of material obtained from PCR and PIR and a 19 g/10 min. MFR (samples 1 and 2) and (ii) WM184 which is a polypropylene homopolymer having a MFR of 23 dg/min. and sourced from PCR (samples 4 and 5). WM184 is commercially available from WellMark Plastics while Copolymer BANYAN 1582 is commercially available from Banyan Plastics. Sample 1 contained 5946WZ and 30% Copolymer BANYAN 1582, Sample 2 contained 5946WZ, 30% Copolymer BANYAN 1582 and 10% of the 3962 rheology modifier; Sample 3 contained 5946WZ, 30% Copolymer Banyan 1582 and 0.2% Peroxide 101; Sample 4 contained 5946WZ and 30% WM184, Sample 5 contained 5946WZ, 30% WM1841582 and 10% of the 3962 rheology modifier; and Sample 6 contained 5946WZ, 30% WM184and 0.2 wt. % Peroxide 101 (LUPEROX. LUPEROX 101 organic peroxide is an organic peroxide commercially) available from ARKEMA.

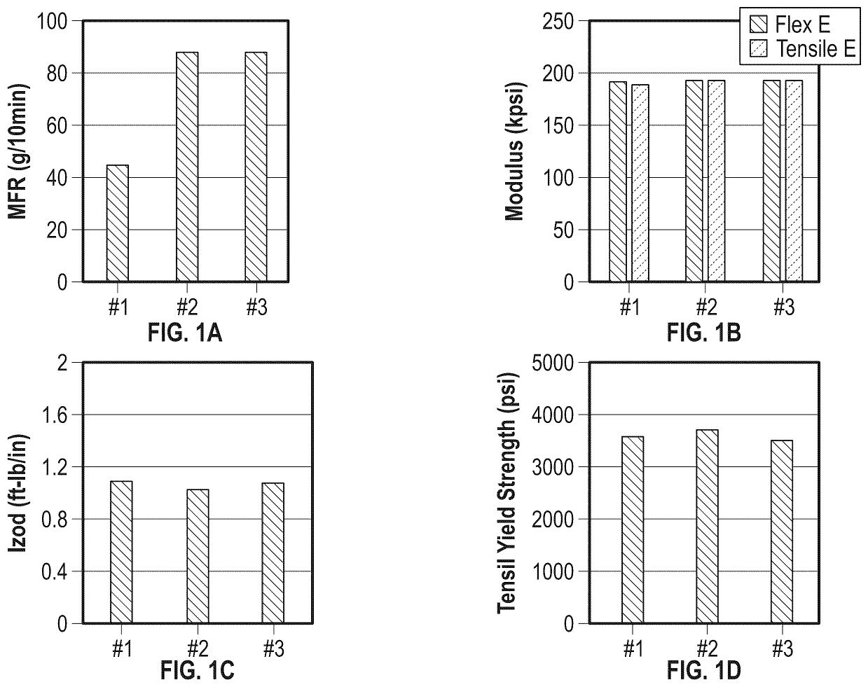

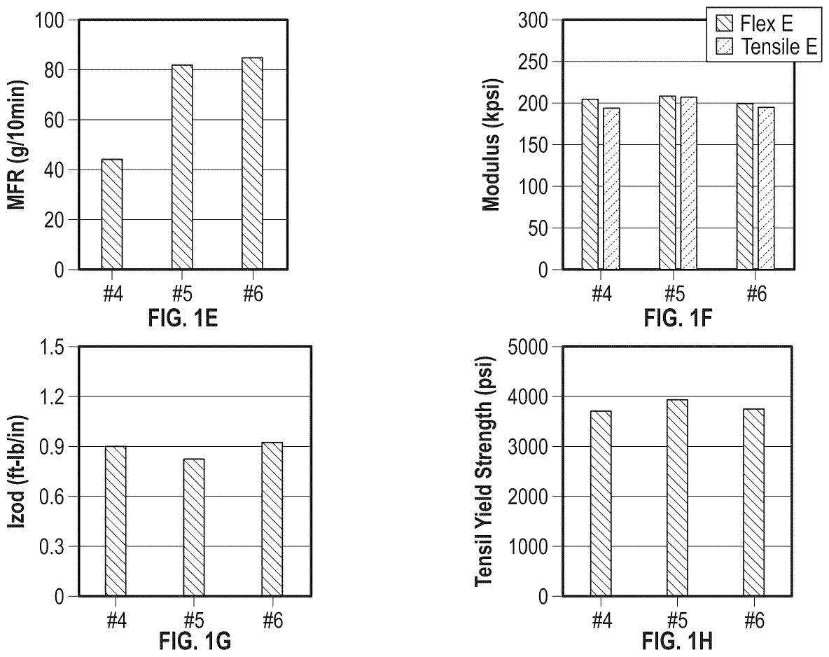

All of the formulations used 5946WZ as the base resin and were compounded using a 27 mm REX twin-screw extruder Reactive Extrusion-LEISTRITZ Micro-27 mm Twin Screw Extruder. The sample constituents and measured properties are presented in Table 1. The MFR for each sample is plotted in FIGS. 1A and 1E, the tensile modulus in FIGS. 1B and 1F, the Izod impact strength in FIGS. 1C and 1G, and the tensile yield strength in FIGS. 1D and 1H.

TABLE 1

| Physical Property (unit) | #1 | #2 | #3 | #4 | #5 | #6 |
|---|---|---|---|---|---|---|
| rPP BANYAN 1582 (wt. %) | 30 | 30 | 30 | 0 | 0 | 0 |
| rPP WM184 (wt. %) | 0 | 0 | 0 | 30 | 30 | 30 |
| Rheology Modifier Peroxide | NO | NO | YES | NO | NO | YES |
| 101 | | | | | | |
| Rheology Modifier 3962 | NO | 10 | NO | NO | 10 | NO |
| (wt. %) | | | | | | |
| MFR (dg/min) | 44.9 | 88.1 | 89.3 | 44.1 | 82.3 | 84.9 |
| First Melt Peak (° C.) | 166.2 | 165.4 | 165.8 | 166.4 | 166.3 | 166.3 |
| Recrystallization Peak (° C.) | 120.7 | 120.6 | 120.9 | 121.7 | 120.9 | 120.9 |
| Second Melt Peak (° C.) | 163.4 | 162.9 | 162.9 | 164.6 | 164.2 | 163.8 |
| % Crystallinity (%) | 41.7 | 43.9 | 42.8 | 44.2 | 44.5 | 42.0 |

Both Table 1 and FIGS. 1A-H indicate that the rheology modifier POLYPROPYLENE 3962 was capable of efficiently increasing the MFR of the rPP-V blend to the level of 80 g/10 min starting from approximately 40 dg/min. POLYPROPYLENE 3962 was an effective rheology modifier using rPP-V that contained either polypropylene homopolymer or polypropylene copolymer. Furthermore, with the incorporation of 10% of POLYPROPYLENE 3962, the rPP-V maintained a desirable level of mechanical performance as indicated by the 190-210 kspi flex modulus, 0.8-1.1 ft-lbs/in Izod impact, and 3700-4000 psi tensile yield strength.

The results demonstrate the efficiency of POLYPROPYLENE 3962 as a rheology modifier in the rPP-V, likely because of (i) its ultra-high MFR associated with low molecular weight, and (ii) unreacted prodegradant residues contributing to further chain scission and MFR increase. The rPP-V compounds formulated with POLYPROPYLENE 3962 possessed desirable mechanical properties and excellent compounding processability, which are beneficial features for the development of high-performance rPP-V formulations.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein. In the event of conflict, the present specification, including definitions, is intended to control.

What is claimed is:

1. A method of preparing a vis-broken recycled polypropylene, the method comprising:
contacting (i) a recycled polypropylene and (ii) an optional virgin polypropylene with a rheology modifier to form a mixture; and
subjecting the mixture to reactive extrusion.

2. The method of claim 1, wherein the recycled polypropylene is sourced from recycled polymer waste.

3. The method of claim 2, wherein the recycled polymer waste comprises post-consumer waste.

4. The method of claim 2, wherein the recycled polymer waste comprises post-industrial waste.

5. The method of claim 1, wherein the recycled polypropylene comprises a polypropylene homopolymer, a polypropylene impact copolymer, a polypropylene random copolymer or combinations thereof.

6. The method of claim 1, wherein the recycled polypropylene has a density of from about 0.85 g/cc to about 0.92 g/cc as determined in accordance ASTM D1505.

7. The method of claim 1, wherein the recycled polypropylene has a melt flow rate, of from about 1 dg/min. to about 50 dg/min as determined in accordance with ASTM D1238.

8. The method of claim 1, wherein the recycled polypropylene has a flexural modulus of from about 100 Kpsi to about 300 Kpsi as determined in accordance with ASTM D790.

9. The method of claim 1, wherein the recycled polypropylene has a tensile yield strength of from about 2000 psi to about 6000 psi as determined in accordance with ASTM D638.

10. The method of claim 1, wherein the recycled polypropylene has an Izod impact of from about 0.2 ft-lb/in to about 5.0 ft-lb/in as determined in accordance with ASTM D-256.

11. The method of claim 1, wherein the recycled polypropylene has a recrystallization peak of from about 70° C. to about 140° C.

12. The method of claim 1, wherein the recycled polypropylene has a peak melt ranging from about 130° C. to about 170° C.

13. The method of claim 1, wherein the recycled polypropylene has a percentage crystallinity ranging from about 20% to about 70%.

14. The method of claim 1, wherein the rheology modifier has a reactive peroxide content level of equal to or less than about 2000 parts per million (ppm).

15. The method of claim 1, wherein the rheology modifier comprises a polypropylene homopolymer having a melt flow rate of from about 600 g/10 min to about 2200 g/10 min.

16. The method of claim 1, wherein the rheology modifier has a weight average molecular weight of from about 90,000 g/mol to about 150,000 g/mol.

17. The method of claim 1, wherein the virgin polypropylene is characterized by a molecular weight distribution of from about 2.0 to about 15.

18. The method of claim 1 wherein the virgin polypropylene has a density of from about 0.85 g/cc to about 0.92 g/cc.

19. The method of claim 1, wherein the virgin polypropylene has a MFR of from about 1 dg/min to about 200 dg/min as determined in accordance with ASTM D-1238.

20. The method of claim 1, wherein the virgin polypropylene has a tensile modulus ranging from about 100 kpsi to about 300 kpsi as determined in accordance with ASTM D-638.

21. The method of claim 1, wherein the virgin polypropylene has an Izod impact strength ranging from about 0.2 ft-lb/in to about 10 ft-lb/in as determined in accordance with ASTM D-256A.
